(19) United States
(12) Patent Application Publication
(10) Pub. No.: US 2006/0091809 A1
(43) Pub. Date: May 4, 2006

(54) Flat lamp

(75) Inventors: Sang-hun Jang, Gyeonggi-do (KR); Hidekazu Hatanaka, Gyeonggi-do (KR); Young-mo Kim, Gyeonggi-do (KR); Seong-eui Lee, Gyeonggi-do (KR); Gi-young Kim, Gyeonggi-do (KR); Seung-hyun Son, Gyeonggi-do (KR); Hyoung-bin Park, Gyeonggi-do (KR)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Samsung Corning Co., Ltd., Gyeonggi-do (KR)

(21) Appl. No.: 11/200,119

(22) Filed: Aug. 10, 2005

(30) Foreign Application Priority Data
Oct. 29, 2004 (KR) 10-2004-0087036

(51) Int. Cl. H01J 1/62; H01J 63/04

(52) U.S. Cl. 313/634; 313/495; 313/581

(57) ABSTRACT

An embodiment is provided of a flat lamp that may include: a lower substrate and an upper substrate arranged to face each other and separated by a predetermined distance, with a plurality of discharge cells formed between the lower substrate and the upper substrate; a plurality of first spacers formed between the lower substrate and the upper substrate and dividing the discharge cells in a first direction; and first electrodes and second electrodes formed in pairs in the first spacers, each pair of the first electrode and the second electrode being present in each of the discharge cells.

### BACKGROUND OF THE DISCLOSURE

This application claims the benefit of Korean Patent Application No. 10-2004-0087036, filed on Oct. 29, 2004, in the Korean Intellectual Property Office, the disclosure of which is incorporated herein in its entirety by reference.

1. Field of the Disclosure

The present invention relates to a flat lamp, and more particularly, to a flat lamp which can improve brightness and uniformity of brightness.

2. Description of the Related Art

Flat lamps which are usually used as back lights for liquid crystal displays (LCDs) have developed from edge-light or direct-light type flat lamps using conventional cold cathode fluorescent lamps to surface-discharge or facing-discharge type flat lamps in which the entire space below a light emitting surface is a discharge space in consideration of luminous efficiency, uniformity of brightness, and the like.

Although a surface-discharge flat lamp has the advantage of having a stable discharge compared to a facing-discharge flat lamp, the entire brightness of the surface discharge flat lamp is inferior to that of the facing-discharge flat lamp.

FIG. 1 is a view of a conventional surface-discharge type flat lamp. Referring to FIG. 1, a lower substrate 10 and an upper substrate 20 is arranged to face each other and separated by a predetermined distance. Discharge cells 15 in which plasma discharges occur are formed between the lower substrate 10 and the upper substrate 20 and filled with a discharge gas.

A plurality of spacers 14 are formed between the lower and upper substrates 10 and 20 such that a constant distance between the lower and upper substrates 10 and 20 is maintained and the spacers 14 divide a space between the lower and upper substrates 10 and 20 to form the discharge cells 15. A fluorescent layer 30 is formed on inner surfaces of the discharge cells 15. The fluorescent layer 30 is excited by UV light which is generated during the plasma discharges, producing visible light.

A pair of the first lower electrode 12a and a second lower electrode 12b and a pair of a first upper electrode 22a and a second upper electrode 22b are formed on outer surfaces of the lower substrate 10 and the upper substrate 20, respectively, for each of the discharge cells 15. An identical electrical potential (for example, 1000 V) is applied between the first upper electrode 22a and the first lower electrode 12a, and thus, a plasma discharge is not induced between them. Also, an identical electrical potential (for example, 0 V) is applied between the second upper electrode 22b and the second lower electrode 12b, and thus, a plasma discharge is not induced between them. However, a predetermined electrical potential difference is present between the first upper electrode 22a and the second upper electrode 22b and also, between the first lower electrode 12a and the second lower electrode 12b, respectively, and thus, a plasma discharge is induced parallel to the upper substrate 20 and the lower substrate 10, respectively.

However, in the flat lamp illustrated in FIG. 1, when visible light generated due to the plasma discharge is transmitted through the upper substrate 20, the visible light is blocked by the first and second upper electrodes 22a and 22b, thereby decreasing brightness and uniformity of brightness.

### SUMMARY OF THE DISCLOSURE

Embodiments of the present invention provide a flat lamp which may improve brightness and uniformity of brightness.

According to an aspect of the present invention, there may be provided a flat lamp comprising: a lower substrate and an upper substrate arranged to face each other and separated by a predetermined distance, with a plurality of discharge cells formed between the lower substrate and the upper substrate; a plurality of first spacers formed between the lower substrate and the upper substrate and dividing the discharge cells in a first direction; and first electrodes and second electrodes formed in pairs in the first spacers, each pair of the first electrode and the second electrode being present in each of the discharge cells.

The first electrodes and the second electrodes may be formed along a length direction of the first spacers.

The flat lamp may further comprise a plurality of second spacers formed between the lower substrate and the upper substrate and dividing the discharge cells in a second direction. The second direction may be perpendicular to the first direction.

Third electrodes and fourth electrodes may be alternately formed in the second spacers. In this case, the third electrodes and the fourth electrodes may be formed along a length direction of the second spacers.

The third electrodes and the fourth electrodes may be electrically connected to the first electrodes and the second electrodes, respectively.

The flat lamp may further comprises fifth electrodes and sixth electrodes formed in pairs on at least one of the lower substrate and the upper substrate, each pair of the fifth electrode and the sixth electrode being present in each of the discharge cells. The fifth electrodes and the sixth electrodes may be formed parallel to the first spacers or perpendicular to the first spacers.

According to another aspect of the present invention, there may be provided a flat lamp comprising: a substrate; a plurality of caps attached to the substrate to form discharge cells therein; and first electrodes and second electrodes formed in pairs, each pair being present on both sidewalls of each of the caps.

Each pair may be formed on outer surfaces of both opposite sidewalls of each of the caps.

The substrate may be made of glass and a plurality of through holes may be formed in the substrate, the through holes penetrating through bottoms of the discharge cells.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view of a conventional flat lamp;

FIG. 2 is a top view of a flat lamp according to an embodiment of the present invention;

FIG. 3 is a longitudinal cross-sectional view of a portion of the flat lamp illustrated in FIG. 2;

FIG. 4 is a transverse cross-sectional view of a portion of the flat lamp illustrated in FIG. 2;

FIG. 5 is a cross-sectional view of a portion of a modified example of the flat lamp illustrated in FIG. 2;

FIG. 6 is a perspective view of a flat lamp according to another embodiment of the present invention; and

FIG. 7 is a cross-sectional view of a portion of the flat lamp illustrated in FIG. 6.

### DETAILED DESCRIPTION OF THE EXEMPLARY EMBODIMENTS OF THE DISCLOSURE

Hereinafter, exemplary embodiments of the present invention will be described in more detail with reference to the attached drawings. Like reference numerals in the drawings denote like elements.

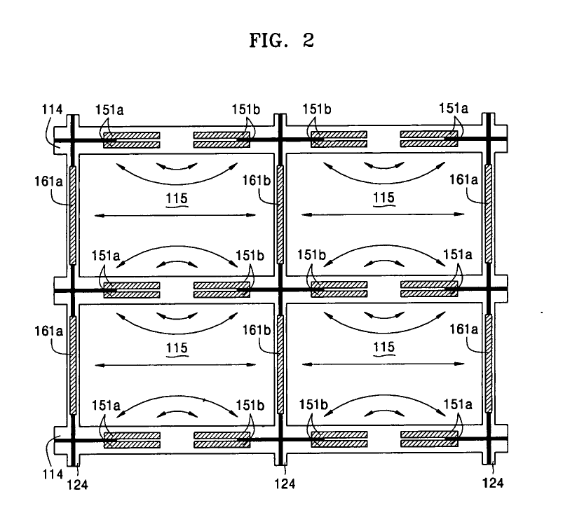

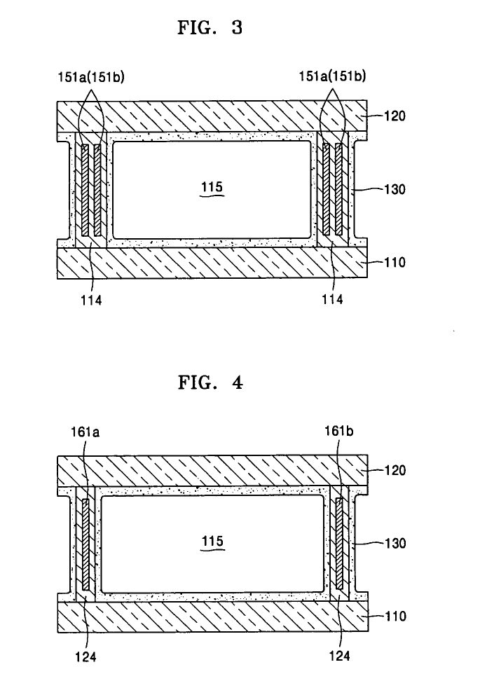

FIG. 2 is a top view of a flat lamp according to an embodiment of the present invention. FIG. 3 is a longitudinal cross-sectional view of a portion of the flat lamp illustrated in FIG. 2. FIG. 4 is a transverse cross-sectional view of a portion of the flat lamp illustrated in FIG. 2.

Referring to FIGS. 2 through 4, a lower substrate 110 and an upper substrate 120 may be arranged to face each other and separated by a predetermined distance. In general, the lower substrate 110 and the upper substrate 120 may be made of glass. A plurality of discharge cells 115 in which plasma discharge occurs may be formed between the lower substrate 110 and the upper substrate 120 and filled with a discharge gas. A frame (not shown) may be formed along edges of the lower substrate 110 and the upper substrate 120 such that a space between the lower substrate 110 and the upper substrate 120 may be closed.

A plurality of first spacers 114 and second spacers 124 may be formed between the lower and upper substrates 110 and 120 such that a constant distance between the lower and upper substrates 110 and 120 is maintained and the first spacers 114 and the second spacers 124 divide the discharge cells 115. The first spacers 114 may divide the discharge cells 115 in a first direction (a longitudinal direction in FIG. 2); and the second spacers 124 may divide the discharge cells 115 in a second direction (a transverse direction in FIG. 2), which is perpendicular to the first direction.

A fluorescent layer 130 may be formed on inner surfaces of the lower and upper substrates 110 and 120 and sidewalls of the first and second spacers 114 and 124. The fluorescent layer 130 may be excited by UV light emitted due to plasma discharges in the discharge cells 115 to emit visible light.

First electrodes 151a and second electrodes 151b may be formed in pairs in the first spacers 114, each pair of the first electrode and the second electrode being present in each of the discharge cells 115. The first electrodes 151a and the second electrodes 151b may be formed along a length direction of the first spacers 114. The plasma discharge may occur in the discharge cells 115 due to a predetermined voltage difference between the first electrodes 151a and the second electrodes 151b. Thus, a surface discharge may occur in each of the discharge cells 115 by a pair of the first electrode 151a and the second electrode 151b formed adjacent to each other in each of the first spacers 114.

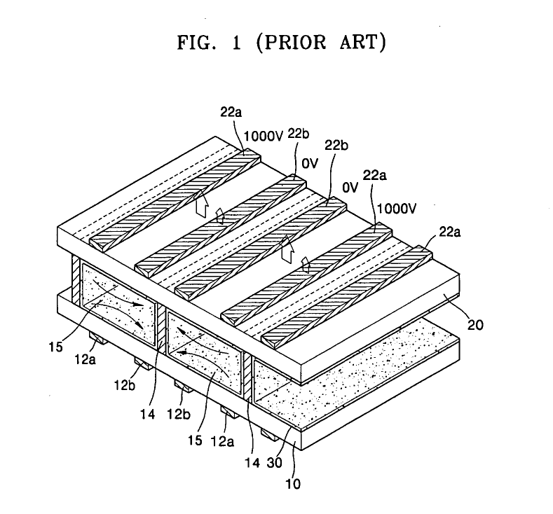

When the first electrodes 151a and the second electrodes 151b are formed in pairs in the first spacers 114, each pair being present in each of the discharge cells 115, visible light produced in the discharge cells 115 to exit toward the upper substrate 120 is not blocked by the first electrode 151a and the second electrode 151b, thereby increasing brightness and uniformity of brightness. In addition, UV light emitted due to the discharge may be uniformly transmitted to the fluorescent layer 130 formed on the inner surfaces of the discharge cells 115, thereby increasing brightness and luminous efficiency. In experiments, a flat lamp comprising the first electrodes 151a and the second electrodes 151b formed in pairs in the first spacers 114, as described above, had a luminous efficiency higher by about 32% than the conventional flat lamp illustrated in FIG. 1.

Discharge electrodes may be further formed in the second spacers 124. Specifically, third electrodes 161a and fourth electrodes 161b may be alternately formed in the second spacers 124 for each of the discharge cells 115. In this case, the third electrodes 161a and the fourth electrodes 161b may be formed along a length direction of the second spacers 124. The third electrodes 161a and the fourth electrodes 161b may be electrically connected to the first electrodes 151a and the second electrodes 151b, respectively. In this case, an identical voltage may be applied between the first electrodes 151a and the third electrodes 161a and an identical voltage may be applied between the second electrodes 151b and the fourth electrodes 161b. A predetermined voltage difference may be present between the first electrodes 151a and the second electrode 151b and also, between the third electrodes 161a and the fourth electrodes 161b.

When the third electrodes 161a and the fourth electrodes 161b are alternately formed in the second spacers 124, facing discharge occurs by the third electrodes 161a and the fourth electrodes 161b, as well as the surface discharge occurs by the first electrode 151a and the second electrode 151b formed in the first spacers 114. Thus, brightness and uniformity of brightness can be increased.

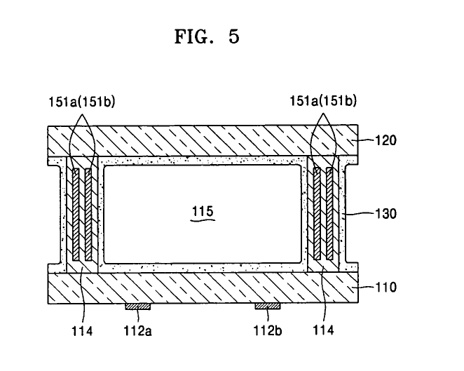

FIG. 5 is a cross-sectional view of a portion of a modified example of the flat lamp illustrated in FIG. 2. Referring to FIG. 5, for each of the discharge cells 115, a pair of a first electrode 151a and a second electrode 151b may be formed in the first spacers 114 dividing the discharge cells 115 in a first direction. Further, fifth electrodes 112a and sixth electrodes 112b may be formed in pairs on a lower substrate 110, each pair of the fifth electrode 112a and the sixth electrode 112b being present in each of the discharge cells 115. The fifth electrodes 112a and the sixth electrodes 112b may be formed parallel to the first spacers 114. Alternatively, the fifth electrodes 112a and the sixth electrodes 112b may be formed perpendicular to the first spacers 114. As described above, a plurality of second spacers (see FIG. 2, reference numeral 124) dividing the discharge cells 115 in a second direction which is perpendicular to the first direction may be formed between the lower substrate 110 and the upper substrate 120. Third electrodes 161a and fourth electrodes 161b may be alternately formed in the second spacers 124.

When the fifth electrodes 112a and the sixth electrodes 112b are formed in pairs on the lower substrate 110, each pair of the fifth electrode 112a and the sixth electrode 112b being present in each of the discharge cells 115, surface discharge may further occur in the discharge cells 115 by the fifth electrodes 112a and the sixth electrodes 112b, and thus, brightness and luminous efficiency may be increased. Although the structure in which the fifth electrodes 112a and the sixth electrodes 112b are formed only on the lower substrate 110 is explained above, the present invention is not limited thereto and the fifth electrodes 112a and the sixth electrodes 112b may be formed on at least one of the lower substrate 110 and the upper substrate 120.

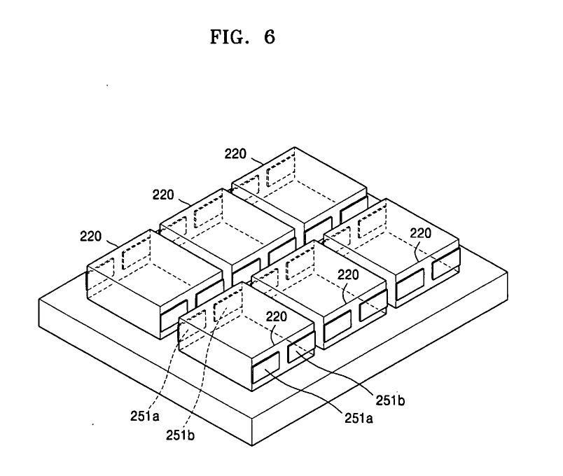

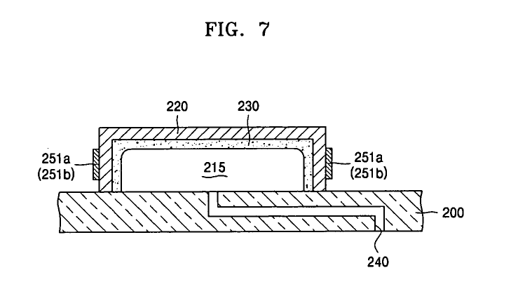

FIG. 6 is a perspective view of a flat lamp according to another embodiment of the present invention. FIG. 7 is a cross-sectional view of a portion of the flat lamp illustrated in FIG. 6.

Referring to FIGS. 6 and 7, a plurality of caps 220 are attached to a substrate 200 to form discharge cells 215 therein. The discharge cells 215 may be filled with a discharge gas. In general, the substrate 200 may be made of glass. The caps 220 may be made of transparent glass through which light can be transmitted.

A fluorescent layer 230 may be formed on inner surfaces of the caps 220. The fluorescent layer 230 may be excited by UV light emitted due to plasma discharges in the discharge cells 215 to emit visible light. A plurality of through holes 240 for injecting a discharge gas into the discharge cells 215 may be formed in the substrate 200, the through holes 240 penetrating through bottoms of the discharge cells 215.

The first electrodes 251a and the second electrodes 251b may be formed in pairs, each pair being present on both sidewalls of each of the caps 220. Each pair may be formed on outer surfaces of both opposite sidewalls of each of the caps 220. The first electrodes 251a may be commonly connected to a first line (not shown) and the second electrodes 251b may be commonly connected to a second line (not shown). The plasma discharge may occur in the discharge cells 215 due to a predetermined voltage difference between the first electrodes 251a and the second electrodes 251b. Thus, a surface discharge may occur in each of the discharge cells 215 by each pair of the first electrode 251a and the second electrode 251b formed on both sides of each of the discharge cells 215.

In the flat lamp illustrated in FIG. 6, visible light produced in the discharge cells 215 to exit toward upper surfaces of the caps 220 is not blocked by the first electrode 251a and the second electrode 251b, thereby increasing brightness and uniformity of brightness. In addition, UV light emitted due to the plasma discharge may be uniformly transmitted to the fluorescent layer 230 formed on the inner surfaces of the caps 220, thereby increasing brightness and luminous efficiency.

The flat lamp illustrated in FIG. 6 may be manufactured by attaching the caps 220 on the substrate 200 and forming the first electrodes 251a and the second electrodes 251b in pairs on both sidewalls of the caps 220. Thus, the flat lamp may be manufactured in a simplified process and using only the substrate 200.

As described above, in the flat lamp according to an embodiment of the present invention, a pair of electrodes may be formed in spacers for each of discharge cells, and thus, visible light exiting toward an upper substrate is not blocked by the electrodes, thereby increasing brightness and uniformity of brightness. In addition, UV light emitted due to the discharge may be uniformly transmitted to a fluorescent layer formed on inner surfaces of the discharge cells, thereby increasing brightness and luminous efficiency.

Further, in the flat lamp according to another embodiment of the present invention, a pair of electrodes may be formed on each of both sidewalls of each of caps, the caps being attached to a substrate to form discharge cells therein, thereby increasing brightness and uniformity of brightness. In addition, the flat lamp can be manufactured in a simplified process.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A flat lamp comprising:
a lower substrate and an upper substrate arranged to face each other and separated by a predetermined distance, with a plurality of discharge cells formed between the lower substrate and the upper substrate;
a plurality of first spacers formed between the lower substrate and the upper substrate and dividing the discharge cells in a first direction; and
first electrodes and second electrodes formed in pairs in the first spacers, each pair of the first electrode and the second electrode being present in each of the discharge cells.

2. The flat lamp of claim 1, wherein the first electrodes and the second electrodes are formed along a length direction of the first spacers.

3. The flat lamp of claim 1, further comprising a plurality of second spacers formed between the lower substrate and the upper substrate and dividing the discharge cells in a second direction.

4. The flat lamp of claim 3, wherein the second direction is perpendicular to the first direction.

5. The flat lamp of claim 4, wherein third electrodes and fourth electrodes are alternately formed in the second spacers.

6. The flat lamp of claim 5, wherein the third electrodes and the fourth electrodes are formed along a length direction of the second spacers.

7. The flat lamp of claim 6, wherein the third electrodes and the fourth electrodes are electrically connected to the first electrodes and the second electrodes, respectively.

8. The flat lamp of claim 5, further comprising fifth electrodes and sixth electrodes formed in pairs on at least one of the lower substrate and the upper substrate, each pair of the fifth electrode and the sixth electrode being present in each of the discharge cells.

9. The flat lamp of claim 8, wherein the fifth electrodes and the sixth electrodes are formed parallel to the first spacers.

10. The flat lamp of claim 8, wherein the fifth electrodes and the sixth electrodes are formed perpendicular to the first spacers.

11. The flat lamp of claim 1, wherein a fluorescent layer is formed on inner surfaces of the discharge cells.

12. A flat lamp comprising:
a substrate;
a plurality of caps attached to the substrate to form discharge cells therein; and
first electrodes and second electrodes formed in pairs, each pair being present on both sidewalls of each of the caps.

13. The flat lamp of claim 12, wherein each pair is formed on outer surfaces of both opposite sidewalls of each of the caps.

14. The flat lamp of claim 12, wherein the caps are made of glass.

15. The flat lamp of claim 12, wherein a plurality of through holes are formed in the substrate, the through holes penetrating through bottoms of the discharge cells.

16. The flat lamp of claim 12, wherein a fluorescent layer is formed on inner surfaces of the caps.
